(19) United States
(12) Patent Application Publication
(10) Pub. No.: US 2012/0098161 A1
(43) Pub. Date: Apr. 26, 2012

(54) FELT FOR FORMING FIBER CEMENT ARTICLES WITH BASE FABRIC WITH PARALLEL MD YARNS

(76) Inventors: Hans Peter Breuer, Zell (DE); Engelbert Diabl, Breitenstein (AT); Daniel Jovanovic, Ternitz (AT)

(21) Appl. No.: 13/280,547

(22) Filed: Oct. 25, 2011

Related U.S. Application Data
(60) Provisional application No. 61/406,278, filed on Oct. 25, 2010.

(51) Int. Cl. D04H 1/08; B29C 33/38

(52) U.S. Cl. 264/337; 442/320; 442/326; 442/268

(57) ABSTRACT

A method of forming a fiber cement article includes the steps of: (a) providing a fiber cement felt, the fiber cement felt comprising a base fabric layer that includes a set of parallel machine direction (MD) yarns; (b) depositing a fiber cement slurry on the fiber cement felt; (c) removing moisture from the slurry; and (d) transferring slurry from the felt to a forming structure.

### RELATED APPLICATION

The present invention claims the benefit of and priority from U.S. Provisional Patent Application Ser. No. 61/406,278, filed Oct. 25, 2010, the disclosure of which is hereby incorporated herein in its entirety.

### FIELD OF THE INVENTION

The present invention relates generally to fabrics, and more particularly to fabrics employed to form articles of fiber cement.

### BACKGROUND OF THE INVENTION

Fiber cement is a well-known material employed in many building components, such as siding, roofing and interior structures, as well as pipes, particularly for waste water transport. Fiber cement typically comprises a mixture of cement (i e , lime, silica and alumina), clay, a thickener, inorganic fillers such as calcium carbonate, and one or more fibrous materials. In the past, asbestos was commonly included as the fibrous material (see U.S. Pat. No. 4,216,043 to Gazzard et al.); because of the well-documented problems asbestos presents, now fiber cement typically includes a natural or synthetic fiber, such as acrylic, aramid, polyvinyl alcohol, polypropylene, cellulose or cotton. Fiber cement is popular for the aforementioned applications because of its combination of strength, rigidity, impact resistance, hydrolytic stability, and low thermal expansion/contraction coefficient.

To be used in siding or roofing components, fiber cement is often formed in sheets or tubes that can be used “as is” or later cut or otherwise fashioned into a desired shape. One technique of forming fiber cement articles (known as the Hatschek process) involves creating an aqueous fiber cement slurry of the components described above, depositing the slurry as a thin sheet or web on a porous fabric belt, and conveying the slurry over and through a series of rollers to flatten and shape the slurry. As the slurry is conveyed, moisture contained therein drains through openings in the fabric. Moisture removal is typically augmented by the application of vacuum to the slurry through the fabric (usually via a suction box located beneath the porous fabric). After passing through a set of press rolls, the fiber cement web can be dried and cut into individual sheets, collected on a collection cylinder for subsequent unrolling and cutting into individual sheets, or collected as a series of overlying layers on a collecting cylinder that ultimately forms a fiber cement tube.

The porous fabric used to support the slurry as moisture is removed is typically woven from very coarse (between about 2500 and 3000 dtex) polyamide yarns. Most commonly, the yarns are woven in a “plain weave” pattern, although other patterns, such as twills and satins, have also been used. Once they are woven, the yarns are covered on the “sheet side” of the fabric (i.e., the side of the fabric that contacts the fiber cement slurry) with a batt layer; on some occasions, the “machine side” of the fabric (i.e., the side of the fabric that does not contact the slurry directly) is also covered with a batt layer. The batt layer assists in the retrieval, or “pick-up,” of the slurry from a vat or other container for processing. Because of the presence of the batt layer(s), the fabric is typically referred to as a fiber cement “felt.”

It may be desirable to provide fiber cement felts in a form that lacks a woven base fabric.

### SUMMARY OF THE INVENTION

As a first aspect, embodiments of the present invention are directed to a method of forming a fiber cement article. The method comprises the steps of: (a) providing a fiber cement felt, the fiber cement felt comprising a base fabric layer that includes a set of parallel machine direction (MD) yarns; (b) depositing a fiber cement slurry on the fiber cement felt; (c) removing moisture from the slurry; and (d) transferring slurry from the felt to a forming structure.

As a second aspect, embodiments of the present invention are directed to a felt for forming fiber cement articles, comprising: a base fabric layer that includes a set of parallel machine direction (MD) yarns; and at least one batt layer overlying the base fabric layer.

### BRIEF DESCRIPTION OF THE FIGURES

FIG. 1 is a schematic illustration of a fiber cement forming apparatus according to embodiments of the present invention.

FIG. 2 is a sectioned perspective view of an exemplary fiber cement felt according to embodiments of the present invention.

FIGS. 2A-2D are cross-sections of exemplary fiber cement felts in according to embodiments of the present invention.

### DETAILED DESCRIPTION OF EMBODIMENTS OF THE INVENTION

The present invention will now be described more fully hereinafter, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, like numbers refer to like elements throughout. Thicknesses and dimensions of some components may be exaggerated for clarity.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein the expression “and/or” includes any and all combinations of one or more of the associated listed items.

As used herein, the terms machine direction (“MD”) and cross machine direction (“CMD”) refer, respectively, to a direction aligned with the direction of travel of the felt on the fiber cement machine, and a direction parallel to the fabric surface and traverse to the direction of travel.

In addition, spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

Well-known functions or constructions may not be described in detail for brevity and/or clarity.

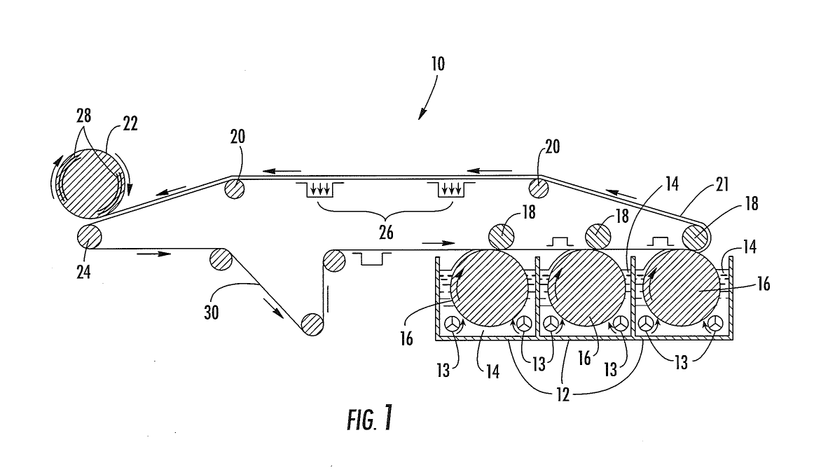

Referring now to FIG. 1, a fiber cement forming apparatus, designated broadly at 10, is illustrated therein. The forming apparatus 10, which performs a typical Hatschek process, generally includes an endless fiber cement felt 30 positioned in rolling contact with and driven by a number of guide rolls 20. Beginning in the lower right corner of FIG. 1, the felt 30 passes above three vats 12, each of which contains a batch of fiber cement slurry 14. As used herein, “fiber cement” means any cementitious composition including cement, silica, and fiber for reinforcement, including asbestos, polyvinyl alcohol, polypropylene, cotton, wood or other cellulosic material, acrylic, and aramid. It is contemplated that other materials such as thickeners, clays, pigments, and the like, that impart desirable processing or performance characteristics to the fiber cement slurry 14 or an article formed therefrom may also be included. Each vat 12 is positioned below a deposition cylinder 16 mated with a couch roll 18. Each vat 12 also includes an agitator 13 that prevents the fiber cement slurry 14 from solidifying therein.

Rotation of each deposition cylinder 16 collects fiber cement slurry 14 on the cylinder's surface; as the felt 30 travels over and contacts the cylinder 16, the slurry 14 is transferred from the cylinder 16 to the felt 30. The amount of slurry 14 deposited on the fabric 30 by each cylinder 16 is controlled by the corresponding couch roll 18. Preferably, the fiber cement slurry 14 is deposited as a web 21 at a thickness of between about 0.3 mm and 3 mm.

Still referring to FIG. 1, once the fiber cement slurry web 21 has been collected on the felt 30 from each of the vats 12, the felt 30 conveys the slurry web 21 over one guide roll 20, then over one or more suction boxes 26 (two are shown in FIG. 1), each of which applies negative pressure to the felt 30, thereby encouraging the removal of moisture from the slurry web 21. Finally, the felt 30 and the slurry web 21 pass over a second guide roll 20, then between the nip formed by a breast roll 24 and a forming roll 22. After passing through the nip, the slurry web 21 has formed into a semi-solid fiber cement sheet 28 that is collected on the surface of the forming roll 22.

Those skilled in this art will recognize that other forming apparatus are also suitable for use with the fiber cement felts of the present invention. For example, felts of the present invention can also be used to form fiber cement pipe. In such an operation, the fiber cement sheet 28 can be collected in contacting layers on a forming roll; as they dry, the overlying layers form a unitary laminated tube. Often, a pipe forming apparatus will include small couch rolls that act in concert with the forming roll to improve interlaminar strength. Also, a second felt may travel over the additional couch rolls to assist in water absorption and finishing.

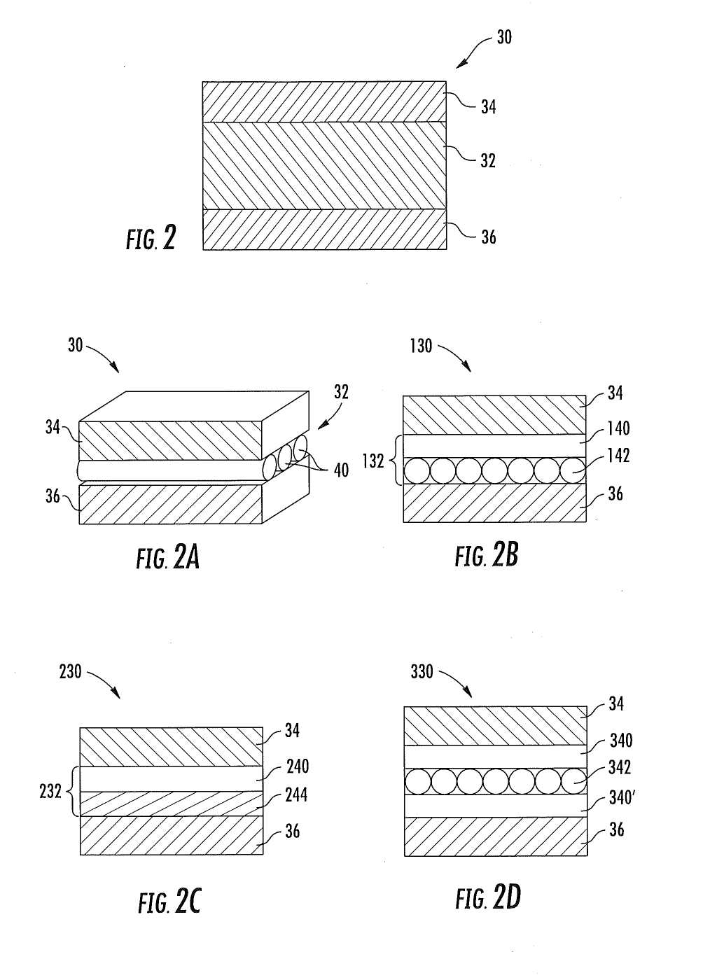

The configuration of the felt 30 can be best understood by reference to FIG. 2. The felt 30 includes a base fabric layer 32 and upper and lower batt layers 34, 36, which are described further below.

The base fabric layer 32 includes a set of parallel yarns extending in the machine direction. As used herein, “parallel yarns” are yarns that extend in the same direction parallel to each other that are not interwoven with other yarns extending perpendicular to them. The base fabric layer 32 may take a number of different forms, some of which are exemplified in FIGS. 2A-2D and discussed in greater detail below.

FIG. 2A illustrates a fiber cement felt 30 in which the base fabric layer 32 comprises yarns 40 extending in parallel with each other in the machine direction of the felt 30. This embodiment represents the most basic form of the felt 30. The yarns 40 may be formed of polypropylene, polyester, aramid, polyamide, or the like, and may have a coarseness from about 500, 1000 or 2000 tex to about 4000 tex. As used herein, “tex” refers to the well-known unit of fineness used to describe textile yarns, in which the number of “tex” is equal to the mass in grams of a 1000 meter length of yarn.

A fiber cement felt having a fabric layer 32 as discussed above may provide significantly better sheet quality than other prior felts, particularly coarse single layer fabrics or double layer fabrics with a coarse upper layer, and may exhibit less of a tendency to mark the product. Also, felts of the present invention may have improved drainage due to more efficient pressure support, and may also have improved compaction resistance. Such felts may also exhibit low elongation in the machine direction (as there are no CMD yarns that bend or crimp the MD yarns), and they may be easier to clean.

FIG. 2B illustrates a fiber cement felt 130 in which the base fabric layer 132 comprises parallel yarns 140 in the machine direction and another set of parallel yarns 142 that extend in the cross-machine direction.

FIG. 2C illustrates a fiber cement felt in which the base fabric layer 232 includes parallel yarns 240 extending in the machine direction and a woven fabric 244.

FIG. 2D illustrates a fiber cement felt 330 with a base fabric layer 332 that includes two sets of parallel yarns 340, 340′ that extend in the machine direction and that sandwich a set of parallel yarns 342 that extends in the cross-machine direction.

In some embodiments, it may be desirable for the base fabric to have certain performance properties that are suitable for use in a fiber cement felt. For example, because of the weight of the fiber cement slurry and the tension that the fiber cement felt experiences when on the rollers, the breaking strength of a fiber cement felt may need to be as high as 250 kilopounds/cm (kp/cm), 350 kp/cm, or even higher, and the fiber cement felt may need sufficient stretch resistance to withstand high tension variations (0-25 kp/cm). The weight of the fiber cement felt is typically between about 1,500-2,300 g/m². Also, the yarns of the fiber cement felt should provide significant abrasion resistance due to the abrasiveness of the fiber cement slurry.

Referring back to FIG. 2, the batt layers 34, 36 of the felt 30 should be formed of a material, such as a synthetic fiber like acrylic, aramid, polyester, or polyamide, or a natural fiber such as wool, that assists in taking up fiber cement slurry 14 from the vats 12 to form the fiber cement web 21. Preferred materials include polyamide, polyester and blends thereof. The weight of the batt layers 34, 36 can vary, although it is preferably that the ratio of batt weight to fabric weight is about between about 1.0 and 2.0 with 1.5 being more preferred. Also, in some embodiments, it may be desirable to omit either or both of the upper and lower batt layers 34, 36. In other embodiments, it may be desirable for multiple batt layers to be present on either side of the base fabric layer 32; for example, two batt layers of different fineness may be present above the base fabric layer 32, with the layer that contacts the fiber cement product being finer than the layer beneath. Typically, the batt layers 34, 36 are attached to the base fabric 32 via needling, although other processes known to those skilled in this art may be employed.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention. The invention is defined by the following claims, with equivalents of the claims to be included therein.

That which is claimed is:

1. A method of forming a fiber cement article, comprising the steps of:
(a) providing a fiber cement felt, the fiber cement felt comprising a base fabric layer that includes a set of parallel machine direction (MD) yarns;
(b) depositing a fiber cement slurry on the fiber cement felt;
(c) removing moisture from the slurry; and
(d) transferring slurry from the felt to a forming structure.

2. The method defined in claim 1, wherein the set of parallel MD yarns comprises a single layer of MD yarns.

3. The method defined in claim 1, wherein the felt further comprises a layer of parallel cross-machine direction (CMD) yarns.

4. The method defined in claim 3, wherein the set of parallel MD yarns is divided into two layers of MD yarns that sandwich the CMD yarn layer.

5. The method defined in claim 1, wherein the felt further comprises a woven fabric layer.

6. The method defined in claim 1, wherein the parallel MD yarns have a coarseness of between about 500 and 4000 tex.

7. The method defined in claim 1, wherein the felt has a strength of greater than 250 kilopounds/cm.

8. The method defined in claim 1, wherein the felt comprises at least one batt layer.

9. A felt for forming fiber cement articles, comprising:
a base fabric layer that includes a set of parallel machine direction (MD) yarns; and
at least one batt layer overlying the base fabric layer.

10. The felt defined in claim 9, wherein the set of parallel MD yarns comprises a single layer of MD yarns.

11. The felt defined in claim 9, further comprising a layer of parallel cross-machine direction (CMD) yarns.

12. The felt defined in claim 11, wherein the set of parallel MD yarns is divided into two layers of MD yarns that sandwich the CMD yarn layer.

13. The felt defined in claim 9, further comprising a woven fabric layer.

14. The felt defined in claim 9, wherein the parallel MD yarns have a coarseness of between about 500 and 4,000 tex.

15. The felt defined in claim 9, wherein the felt has a strength of greater than 250 kilopounds/cm.
